(19) United States
(12) Patent Application Publication
(10) Pub. No.: US 2006/0007672 A1
(43) Pub. Date: Jan. 12, 2006

(54) User wearable LED display

(76) Inventors: Todd R. Benson, Discovery Bay (HK); Ronald Gregory, Discovery Bay (HK)

Correspondence Address: WORKMAN NYDEGGER;(F/K/A WORKMAN NYDEGGER & SEELEY), 60 EAST SOUTH TEMPLE, 1000 EAGLE GATE TOWER, SALT LAKE CITY, UT, 84111, US

(21) Appl. No.: 11/169,594

(22) Filed: Jun. 29, 2005

Related U.S. Application Data
(60) Provisional application No. 60/584,511, filed on Jul. 1, 2004.

(51) Int. Cl. F21V 21/08

(52) U.S. Cl. 362/103

(57) ABSTRACT

A user wearable display apparatus containing a light source that emits light and is positioned so as to illuminate a design on the surface of the display apparatus and attract viewers. The display apparatus also contains a power supply that provides power to the light source. In some embodiments, the invention may also include a promotional display member that displays advertising or sponsoring information. This promotional display member is configured to attach to display apparatus and surround the design on the front surface of the display apparatus.

### CROSS REFERENCE TO RELATED APPLICATIONS

This applications claims the benefit of U.S. Provisional Application Ser. No. 60/584,511, filed Jul. 1, 2004, entitled, “USER WEARABLE LED DISPLAY.”

### THE FIELD OF THE INVENTION

This invention relates to apparatuses worn by users that display designs, slogans, advertisements, pictures, or any other type of information as desired.

### THE RELEVANT TECHNOLOGY

Display apparatuses are widely created and used to display information or promotional materials to the public. A number of different types of displays can be utilized including billboards, signs, banners, decals, pins, bumper stickers, and the like. The information included on such display apparatuses can include designs, slogans, advertisements, messages, and pictures. Such apparatuses are commonly used by commercial entities, political organizations, charitable organizations, educational institutions, and other large entities to promote their various endeavors. Individual persons or smaller entities also commonly create, use, and distribute display apparatuses for such reasons.

User wearable display apparatuses are one type of display apparatus that are commonly used. There are many advantages for using user wearable display apparatuses. One advantage is that most apparatuses are usually small and therefore easy and convenient to use. Once the display apparatus is affixed to a user, it can potentially attract viewers wherever the user carries it. The public can view the apparatus while the wearer participates in normal daily activities, such as such as talking to neighbors or friends, going shopping, walking down a street or through a public area, etc.

Display apparatuses are usually affixed to a user in a manner intended to display information to the public. A major problem occurring with user wearable display apparatuses and the accompanying designs, however, is that some designs may not be sufficiently noticeable to achieve the desired degree of attention from the public. This can be caused by many things, for example, lack of creative design, unattractive design detail, large complex and bulky configurations, etc. Such unnoticeable designs may prevent the display apparatuses from achieving their purpose of attracting the public's attention. Designs that fail to attract the public's attention can defeat the desirability of providing user wearable display apparatuses particularly where a significant amount of time and resources are employed in creating and distributing the apparatus. In view of the foregoing, there is an ongoing need for display apparatuses that help attract viewers, that are capable of attaching to a user, and are easily portable.

### BRIEF SUMMARY OF THE INVENTION

The present invention is directed towards a display apparatus that displays information and is a worn by a user. More specifically, the present invention is a user wearable display apparatus containing a light source that emits light and is positioned so as to illuminate a design on the surface of the display apparatus and attract viewers. The display apparatus also contains a power supply that provides power to the light source. In some embodiments, the invention can also include a promotional display member that displays advertising or sponsoring information. This promotional display member is preferably configured to be attached to the display apparatus and surround the design on the front surface of the display apparatus.

These and other objects and features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates an exemplary display apparatus according to one embodiment of the present invention.

FIG. 2 is a side cross-sectional view of an exemplary display apparatus illustrating an exemplary light source for illuminating a display surface according to one embodiment of the present invention.

FIG. 3 is a side cross-sectional view of an exemplary display apparatus illustrating an exemplary light source for illuminating a display surface according to another embodiment of the present invention.

FIG. 4 illustrates a back surface of a base member of an exemplary display apparatus according to one embodiment of the present invention.

FIG. 5 illustrates a back surface of a base member of an exemplary display apparatus having an enclosed power supply.

FIG. 6 illustrates an exemplary display apparatus having a promotional display member surrounding the display surface and an external power supply according to one embodiment of the present invention.

FIG. 7 illustrates various shapes and configurations that can be utilized with the display apparatus according to one embodiment of the present invention.

FIG. 8 illustrates a number of different attachment apparatuses that can be utilized with the display apparatus according to one embodiment of the present invention.

### DETAILED DESCRIPTION OF THE PREFERRED EMBODIMENTS

The present invention is directed towards a display apparatus that is easily portable and worn by a user to attract the public's attention and display a message. More specifically, the user wearable display apparatus contains a light source that emits light and is positioned so as to illuminate the design on the surface of the display apparatus and attract viewers.

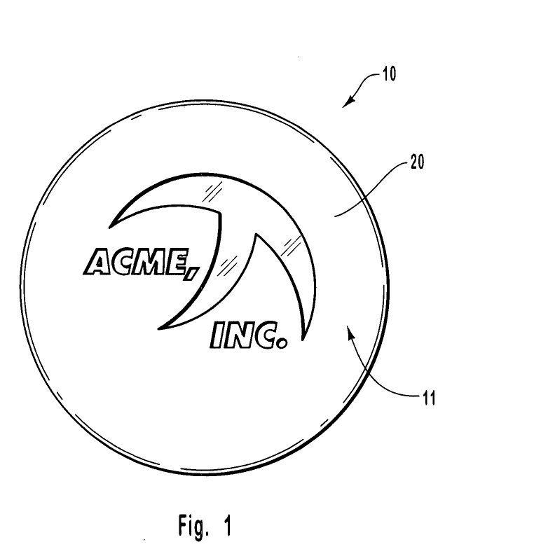

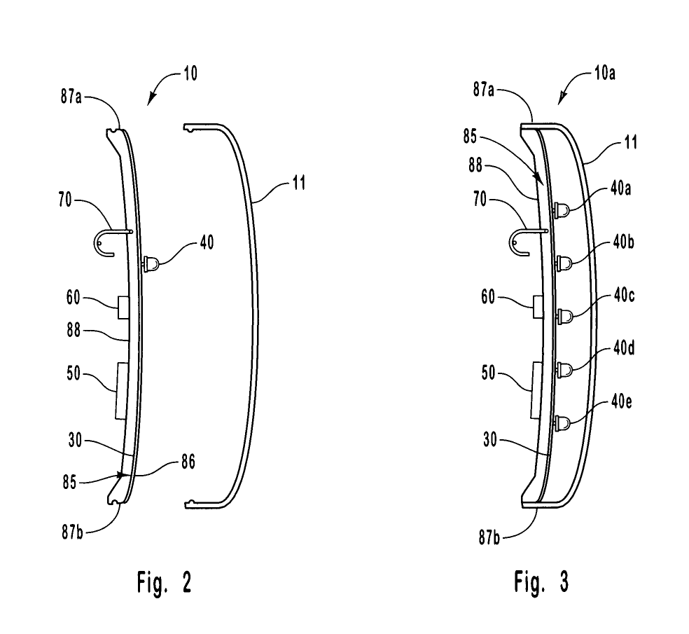

FIG. 1 illustrates a display apparatus 10 that is configured to be worn by a user according to one embodiment of the present invention. In the illustrated embodiment display apparatus 10 includes a display surface 11 having a design 20. Display surface 11 comprises the face of display apparatus 10. Display surface 11 also allows light to shine from a light source and illuminate design 20. In the illustrated embodiment, the light source comprises an internal light source positioned behind display surface 11. Display surface 11 is therefore non-opaque (i.e. transparent or translucent) so as to allow for the illumination of light from internal light source 40. (see FIG. 2).

As will be appreciated by those skilled in the art, any configuration or type of display surface 11 can be utilized that allows light to illuminate a design. Display surface 11 may also be variously shaped or sized, such as being round, square, rectangular, curved, non-curved, or any other geometric shape or size as appreciated by one skilled in the art. In one embodiment, the shape of display apparatus 10 can influence the shape of display surface 11.

Design 20 is configured to portray information or designs on design surface 11. Design 20 is illuminated by light emitted from a light source. Illumination of design 20 can accentuate the design to users. As will be appreciated by those skilled in the art, a variety of types and configurations of designs can be utilized without departing from the scope and spirit of the present invention. The design can be independently connected to or be an integral part of display surface and can extend on all surfaces of display surface including front, sides, and top and bottom. A number of types and configurations of designs can be included on the display surface, such as, but not limited to, characters, words, letters, number, shapes, pictures, slogans, advertisements, and any other design that will capture the attention of the public. Additionally, the display apparatus can be circular, non-circular, any geometric shape, multi-dimensional, thin, thick, have protruding or concave surfaces, or be any other configuration as needed. The display apparatus can also include variations in style or design in displaying their respective information. The display apparatus can be of an assortment of colors, words, letters, numbers, shapes, sizes or any other design known to those common in the art to display their information to be viewed by other persons.

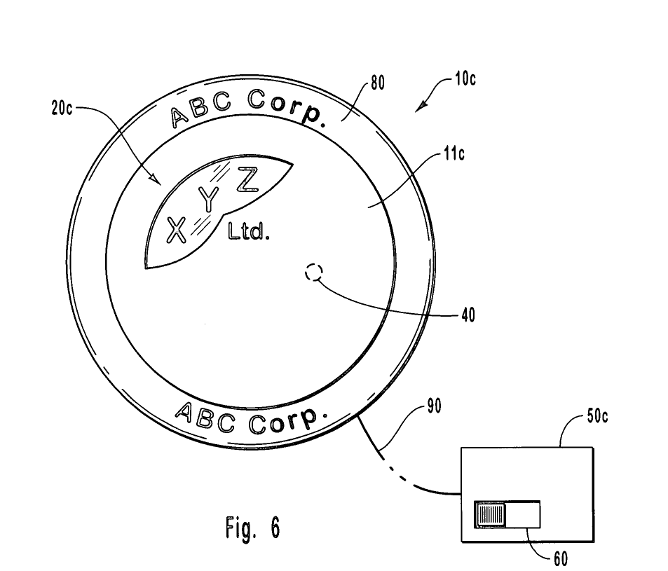

FIG. 2 is a cross-sectional side view of an exemplary display apparatus 10 illustrating the components of display apparatus 10 according to one embodiment of the present invention. In the illustrated embodiment, display apparatus 10 comprises a display surface 11, a reflective member 30, a light source 40, a power supply 50, an actuation mechanism 60, an attachment apparatus 70, and a promotional display member 80 (see FIG. 6).

As previously discussed, display surface 11 is configured to be seen by a user such as by comprising the face of display apparatus 10. In one embodiment, display apparatus 10 is non-opaque in whole, or in part, to allow illumination of display surface 11. For example, in one embodiment, a design of the display surface is translucent while the non-design portion of the display surface is opaque to accentuate the shape of the design over the background display surface. In another example, the design of the display surface is transparent, while the rest of the display surface is translucent to accentuate the design of the display surface while allowing illumination of the entire display surface. In another embodiment, a light source is positioned to illuminate display surface from other than a backlighting configuration. For example, a light source could be positioned adjacent to, or slightly in front of, the display surface to illuminate the display surface.

Base member 85 provides a support structure on which other components of display apparatus 10 are positioned. Base member 85 includes a front surface 86, sides 87a, b, and a back surface 88. Display surface 11 is configured to be secured to base member 85. As will be appreciated by those skilled in the art, a variety of types and configurations of a connection between display surface 11 and base member 85 can be utilized without departing from the scope and spirit of the present invention. For example, in one embodiment notches are included on a display surface that fit into corresponding grooves on a base member or vice versa. In an alternative embodiment, the display surface is threadably coupled to the base member. In yet another embodiment, a display surface is adhesively attached or affixed to the base member.

Reflective member 30 provides a surface that reflects light toward display surface 11 so as to illuminate design 20. Reflective member 30 is preferably connected to front surface 86 and possibly sides 87a, b of base member 85. In the illustrated embodiment, reflective member 30 is positioned behind light source 40 to accentuate and deflect light emitted from light source 40. By accentuating light emitted from light source 40, less candle power need be provided by light source 40 to achieve a desired degree of illumination. In one embodiment, reflective surface 30 is adhesively attached to base member 85. By deflecting light emitted from light source 40, a more generalized illumination is provided rather than a point specific type of illumination. In one embodiment of the present invention, a diffusion apparatus is provided such that most, or all of the light, illuminating display surface 11 is diffused by a reflective or other surface.

As will be appreciated by those skilled in the art, a variety of types and configurations of connections between a base member and a reflective surface can be utilized without departing from the scope and spirit of the present invention. For example, in one embodiment the reflective surface is an integral part of the front surface of a base member. Other methods for providing a reflective surface can be utilized without departing from the scope and spirit of the present invention.

Reflective member 30 can be composed of any surface known in the art that is capable of reflecting or mirroring light in another direction, such as glass, metal, plastic, or other reflective materials, including materials coated with shiny or reflective paint, coatings, or substances. Light may also be diffused by refraction either through interposition of another member with light refraction qualities such as translucence or by the shape of reflective member 30 so that different angles direct the light through the display surface as desired. The shape and size of reflective member 30 can be selected to accommodate the shape and design of base member 85 or display apparatus 10. In another embodiment, the shape/size of a reflective member is different from the shape/size of a base member or display apparatus. The cross-sectional diameter of reflective member 30 can also vary according to the type of reflective material used. As will be appreciated by those skilled in the art, a variety of types and configurations of reflective members can be utilized without departing from the scope and spirit of the present invention. In one embodiment, the display apparatus includes a gobo or other image projections apparatus for conveying an image on a surface.

Light source 40 provides a mechanism for illuminating display surface 11. Light source 40 provides a desired degree of illumination to achieve a desired effect on display surface and or a design positioned on display surface 1l. The light source 40 can provide a light source for illumination of or on the display surface that is constant or intermittent, as by flashing. A variety of types and configuration of light sources can be utilized without departing from the scope and spirit of the present invention. In one embodiment, the light source comprises a light emitting diode (“LED”). In another embodiment, the light source is selected from the group including incandescent bulbs, neon bulbs, florescent bulbs, light emitting chemicals, or other sources of light.

In the illustrated embodiment, light source 40 is configured to connect to a portion of base member 85. In the illustrated embodiment, light source 40 is connected to a front surface 86 and/or sides 87a, b of base member 85. As will be appreciated by those skilled in the art, a variety of types and configurations of attaching a light source to the display apparatus 10 can be utilized without departing from the scope and spirit of the present invention. For example, in one embodiment the light source is attached to a component of the display apparatus other than the base member. In one embodiment, the light source is integrally coupled to the base member. In another embodiment, the light source is suspended between the base and display surfaces to take advantage of reflective and refractive qualities of the base surface and any member interposed between the base surface and the display surface. In another embodiment, the light source is attached to the display surface itself in one or more places or design configurations so as to concentrate or diffuse light in one or more places or as to outline a design or particular elements of a design on part of the display surface. Different light configurations may be adopted to concentrate or diffuse light in different ways either to illuminate all or part of the display surface or to concentrate light on one or more parts of the display surface. As will be appreciated by those skilled in the art a variety of types and configurations of light sources can be utilized with the display apparatus in a variety of manners without departing from the scope and spirit of the present invention.

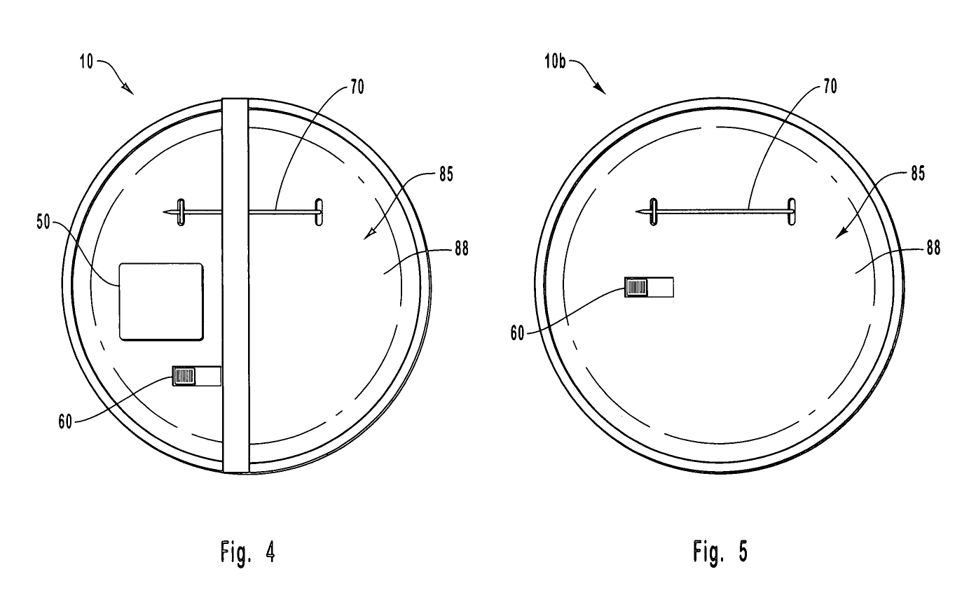

In the illustrated embodiment, power supply 50 provides power to display apparatus 10 and specifically to light source 40. Power supply 50 can comprise a battery pack or other source of power for light source 40. Power supply will be discussed in greater detail with reference to FIG. 4.

Actuation mechanism 60 provides a mechanism allowing the user to activate or deactivate power supply 50, as shown in FIG. 2. Actuation mechanism 60 typically includes a moveable switch or device than enables a user to move actuation mechanism 60 from one position to another. Back surface 88 of base member 85 is configured to attach to actuation mechanism 60. Actuation mechanism 60 is connected to base member 85 such that actuation mechanism 60 partially extends outward from back surface 88 so as to allow a user to adjust actuation mechanism 60. Actuation mechanism will be discussed in greater detail with reference to FIG. 4.

Attachment apparatus 70 provides a mechanism for allowing display apparatus 10 to be worn by a user. In the illustrated embodiment, attachment apparatus 70 is connected to back surface 88 or sides 87 of base member 85 and is capable of being attached to a user. Attachment apparatus 70 is connected to base member 85 and partially extends outward from back surface 88 or from sides 87 so as to allow a user to employ attachment apparatus 70.

FIG. 3 illustrates a cross-sectional view of a display apparatus 10a having a plurality of light sources. In the illustrated embodiment, display surface 11a is integrally coupled to base member 85a. A plurality of light sources 40a-e are coupled to base member 85a. By providing a plurality of light sources 40a-e, a more diffused and consistent amount of lighting is provided from the top of display surface 11a to the bottom of display surface 11a.

As will be appreciated by those skilled in the art, a variety of configurations and numbers of light sources can be provided without departing from the scope and spirit of the present invention. For example, in one embodiment, a plurality of lights are positioned on the entire surface area of the base member to equally cover the base member. In another embodiment, the number and configuration of the light sources are selected to provide a desired effect on the display surface and/or a design positioned on the display surface.

FIG. 4 illustrates the back surface of base member 85 showing a partially covered power supply 50 and an actuation mechanism 60. In the illustrated embodiment, a portion of power supply 50 extends outward from base member 85 and is visible. The amount which power supply 50 extends outward from base member 85 can be selected to result in minimal contact with the user. A variety of types and configurations of power supplies can be utilized without departing from the scope and spirit of the present invention, including but not limited to, battery-operated, rechargeable battery-operated, solar powered, AC powered, DC powered, and other power supplies typically used by those skilled in the art.

A variety of types and configurations of a connection between a base member and a power supply can be utilized without departing from the scope and spirit of the present invention. For example, in the illustrated embodiment a power supply that is only partially covered by a base member and therefore a portion of the power supply may extend outward from the back surface of a base member. In yet another embodiment, a power supply may be completely covered by or located within a base member. In an alternative embodiment, an external power supply is utilized wherein the power supply is located outside of a display apparatus and is connected to the base member and light source by a connection device such as an electrical cord, electrical wire, power cord, etc.

Actuation mechanism 60 is positioned adjacent power supply 50. Actuation mechanism allows a user to actuate or deactuate light source 40 (see FIG. 2). In the illustrated embodiment actuation mechanism 60 is remotely connected to power supply 50. As can be appreciated by those skilled in the art, a variety of types and configurations of attachment between actuation mechanism 60 and power supply 50 can be utilized without departing from the scope and spirit of the invention. In one embodiment, actuation mechanism 60 and power supply 50 are connected utilizing electrical wiring 90 (see FIG. 6). The electrical wiring allows the current of power supply 50 to be activated or deactivated by moving actuation mechanism 60 from a first position to a second or third position or “on and off” or flashing position.

As will be appreciated by those skilled in the art, a variety of types and configurations of a connection between a base member and an actuation mechanism can be utilized without departing from the scope and spirit of the present invention. In one embodiment, actuation mechanism is integrally formed with a power supply. For example, in the illustrated preferred embodiment, an actuation mechanism is remotely connected to a partially covered power supply by a connection device such as an electrical wire. In alternative embodiments, an actuation mechanism may be integrally connected to an internal power supply but is configured to extend outward from the back surface of a base member to be actuated by a user. The present invention includes all types of switches/devices commonly used in the art for such purposes. In a preferred embodiment, the actuation mechanism is a switch that extends from the back surface or side of a base member that is moveable from a first position to a second position, thereby activating or deactivating a power supply.

In the illustrated embodiment, display apparatus includes an attachment apparatus 70 in the form of a pin. As already disclosed, this invention includes a variety of types and configurations of attachment apparatuses that are capable of affixing a display apparatus to a user. As will be appreciated by those skilled in the art, a variety of types and configurations of a connection between a base member and an attachment apparatus can be utilized without departing from the scope and spirit of the present invention. For example, an attachment apparatus can be adhesively attached or affixed to a base member utilizing known methods. The type of attachment apparatus 70 can be used to determine the correct placement and connection of attachment apparatus 70 to base member 85.

As will be appreciated by those skilled in the art, a variety of types and configurations of connections between the base member and the attachment apparatus can be utilized without departing from the scope and spirit of the present invention. For example, the attachment apparatus be adhesively attached or affixed to a base member utilizing known methods. The type of attachment apparatus 70 can be used to determine the correct placement and connection of attachment apparatus 70 to base member 85.

As will be appreciated by those skilled in the art, a variety of types and configurations of an attachment apparatus can be utilized without departing from the scope and spirit of the present invention. For example, in one embodiment the attachment apparatus comprises a pin that is connected to the back surface of a base member and is capable of being pinned onto a user's clothing. In another embodiment a clamp is utilized that is connected to the back surface of a base member and can slide onto a user's shirt pocket or other article of clothing. In yet another embodiment, the top side surface of a base member can be connected to a neck tie that is worn around a user's neck and allows a display apparatus to hang close to the user's chest. These examples are non-limiting and the present invention includes all types of attachment apparatus that are commonly known and used in the art.

FIG. 5 illustrates an exemplary display apparatus 10b showing a back surface 88 of base member 85. In the illustrated embodiment, a power supply is positioned internal to base member 85. In the illustrated embodiment, the power supply is completely enclosed by back surface 88 of base member 85. This allows the power supply to be effectively isolated from a user wearing user wearable display 10b. In one embodiment, an actuation mechanism can be integrally connected to an internal power supply and is configured to be the only component that extends outward from the back surface of a base member. In another embodiment, the actuation mechanism is remotely connected to an internal power supply by an electrical wire, RF signal, remote infrared device, or other connection device known to those skilled in the art

FIG. 6 illustrates a display surface 11c of a display apparatus 10c having a promotional border 80 and an external power supply 50c. Design 20c is positioned on display surface 11c and is illuminated by an internal light source 40 positioned internal to display surface 11c. In the illustrated embodiment, a promotional display member 80 is positioned adjacent display surface 11c. Promotional display member 80 displays advertising, sponsoring, or other types of information.

In the illustrated embodiment, promotional display member 80 surrounds display surface 11c. Promotional display member 80 can be an integrally coupled to other components of display apparatus 10c or selectively couplable to display apparatus 10c. In one embodiment, a different display member 80 can be exchanged for a display member currently being utilized. The display member 80 can be utilized for sponsorship, promotional, informational material. For example, manufacturing and distribution of a pin can be paid for by selling the advertising space of the promotional display member.

A variety of different types and configurations of display members can be utilized without departing from the scope and spirit of the present invention. For example, in one embodiment, the display member is positioned across a portion or underneath the pin rather than circumscribing the display surface. In another embodiment, the display member is configured to be attached to the top, bottom, side, or other surface of the apparatus. In another embodiment, the shape of the display member corresponds to the shape of the display surface. For example, in one embodiment, a rectangular display member is attached to the top and/or bottom of a rectangular display surface. As will be appreciated by those skilled in the art, a variety of types and configurations of connections between promotional display member and other components of the display apparatus can be utilized without departing from the scope and spirit of the present invention. For example, in one embodiment, one or more sides of a base member include grooves in which protrusions from a promotional display member attach. In an alternative embodiment, the inner edge of promotional display member slides into a continuous groove that is provided surrounding the sides of a base member. In yet other embodiments, a promotional display member can be adhesively attached or affixed to a base member.

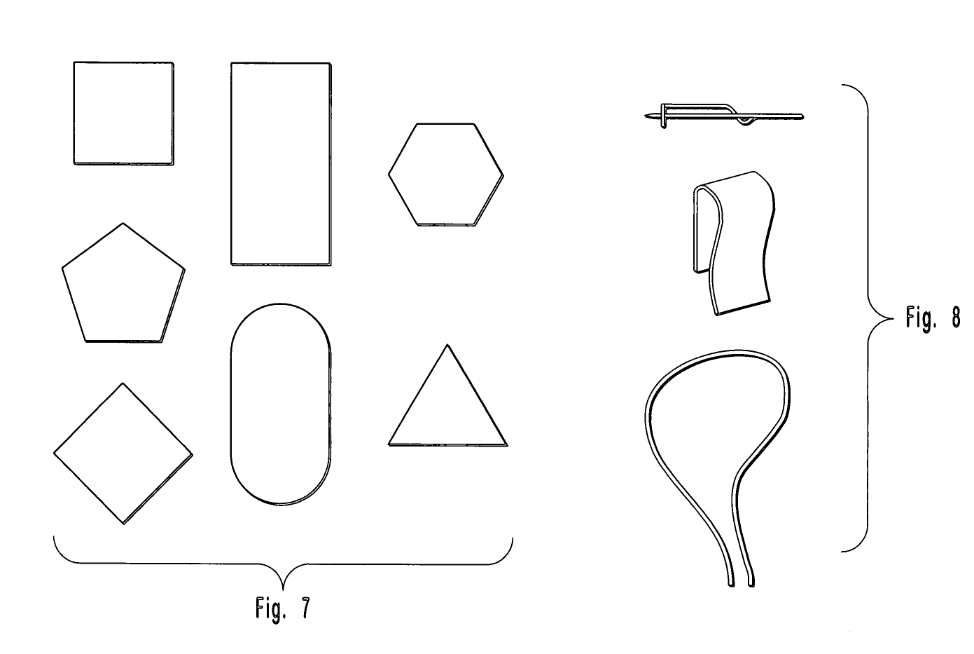

FIG. 7 illustrates various shapes of display apparatuses that can be utilized. However, as will be appreciated by those skilled in the art, a variety of shapes, types, and configurations of a display apparatus may be utilized without departing from the scope and spirit of the present invention.

FIG. 8 illustrates various forms of attachments that may be utilized in the present invention. As will be appreciated by those skilled in the art, a variety of types, and configurations of forms of attachment may be utilized without departing from the scope and spirit of the present invention.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A display apparatus designed to be worn by a user comprising:
a display surface; and
a light source for illuminating the display surface.

2. The display apparatus of claim 1, wherein the shape of the display is selected from one of the following, circular, rectangular, oval, square, pentagonal, hexagonal, triangular, or any other shape.

3. The display apparatus of claim 1, wherein the display has a removable and replaceable promotional display member with a design usually used for advertising purposes.

4. The display apparatus of claim 3, wherein the removable and replaceable promotional display member is a border that that surrounds or is attached above, beneath, or to the side of the display.

5. The display apparatus of claim 1, wherein the light source is positioned behind the display surface for backlighting the display surface.

6. The display apparatus of claim 5, wherein the display surface is non-opaque allowing backlighting of the display surface.

7. The display apparatus of claim 6, wherein a design is utilized with the display surface such that backlighting of the display surface allows greater visibility of the design utilized with the display surface.

8. A user wearable display comprising:
a display surface having at least a portion that is non-opaque;
a design positioned on the display surface;
a light source positioned behind the non-opaque display surface that emits light so as to provide greater visibility of the design positioned on the display surface;
a power supply capable of providing power to the light source; and
an actuation mechanism that activates or de-activates the power supply.

9. The user wearable display of claim 8, wherein the non-opaque portion of the display surface is translucent.

10. The user wearable display of claim 8, wherein the non-opaque portion of the display surface is transparent.

11. The user wearable display of claim 8, wherein the display surface includes a translucent portion and a transparent portion.

12. The user wearable display of claim 8, wherein the display surface includes a first portion that has a first degree of translucence and second portion that has a second degree of translucence.

13. The user wearable display of claim 8, wherein the display has a removable and replaceable promotional display member with a design usually used for advertising purposes.

14. The user wearable display of claim 13, wherein the removable and replaceable promotional display member is a border that that surrounds or is attached to above, beneath, or to the side of the display.

15. The user wearable display of claim 8, wherein the light source comprises an light emitting diode.

16. The user wearable display of claim 15, wherein the light source comprises a plurality of light emitting diodes.

17. The user wearable display of claim 16, wherein the light emitting diodes can be actuated and deactuated to create desired visual effects.

18. The user wearable display of claim 8, further comprising a logic module for use with the light source to create varying visual effects during operation.

19. The user wearable display of claim 18, wherein the logic module actuates or deactuates one or more portions of the light source to create desired visual effects during operation.

20. A display apparatus designed to be worn by a user comprising:
a semi-transparent display surface;
a design on the face of the display surface that can be variously configured so as to suit various purposes;
a supporting base member;
a reflective member on or near the base member that reflects light;
one or more light emitting diodes on or near the base member that is capable of emitting light;
a self-contained battery that is used to provide power to the light emitting diode;
an on-off switch used to activate or deactivate the battery; and
a form of attachment so as to attach the display apparatus to the user.
